(19) United States
(12) Patent Application Publication
(10) Pub. No.: US 2015/0074910 A1
(43) Pub. Date: Mar. 19, 2015

(54) ORTHOPEDIC SHOULDER PILLOW

(71) Applicants: Christopher Bieniek, Fortville, IN (US); Kristi Bieniek, Fortville, IN (US)

(72) Inventors: Christopher Bieniek, Fortville, IN (US); Kristi Bieniek, Fortville, IN (US)

(21) Appl. No.: 14/549,711

(22) Filed: Nov. 21, 2014

Related U.S. Application Data
(63) Continuation of application No. 13/480,756, filed on May 25, 2012.

(51) Int. Cl. A61G 7/07; A47C 20/02; A47G 9/10

(52) U.S. Cl. CPC A61G 7/07; A47G 9/10; A47C 20/02; A47G 2009/1018
USPC 5/630

(57) ABSTRACT

An orthopedic pillow designed to address the limitations in current available shoulder pillows. An orthopedic pillow according to at least one embodiment of the present disclosure has a bottom surface bounded by a leading edge, a trailing edge, and first and second side edges; a first end surface intersecting with the leading edge and oriented perpendicular to the bottom surface; a second end surface intersecting with the trailing edge and oriented perpendicular to the bottom surface; and a contoured upper surface extending from the first side edge to second side edge, the contoured upper surface intersecting with the first end surface and the second end surface.

### RELATED APPLICATION

This application is a continuation of U.S. application Ser. No. 13/480,756, filed May 25, 2012.

### BACKGROUND

A person lying in a lateral decubitus position, such as, for example, during a surgical procedure or during sleep, exerts strain on the person's shoulder joint. Prior art pillows and positioning devices claim to relieve such shoulder strain by supporting the head and neck, but in doing so place the person's arm in a poor physiologic position or a forced or limited position. Such prior art pillows and positioning devices do not provide lateral support of the torso or allow for variable positioning of the shoulder for the best possible relief of shoulder impingement and pain. Additionally, such prior art pillows and positioning devices do not reduce joint reactive forces while providing lateral support for the torso and maximum number of effective arm positions. For example, certain prior art pillows force the person's arm under the pillow, which impinges the rotator cuff and subacromial bursa beneath the acromion. Other prior art pillows have an attached head piece and a basic non-contoured pillow wedge to support the torso and limited adaption to different size body habitus, which does not lessen the pressure upon the shoulder.

For the foregoing reasons, it is desired to provide an improved orthopedic shoulder pillow.

### SUMMARY

The present disclosure includes disclosure of an orthopedic pillow designed to address the limitations in current available shoulder pillows. In at least one embodiment, an orthopedic pillow or the present disclosure used in accordance with the methods of the present disclosure provides contoured lateral support of a person's torso of various sizes and allows for various sleeping positions while also allowing variable arm positions, all in a compact portable size.

In at least one embodiment, an orthopedic pillow according to the present disclosure comprises a bottom surface bounded by a leading edge, a trailing edge, and first and second side edges; a first end surface intersecting with the leading edge and oriented perpendicular to the bottom surface; a second end surface intersecting with the trailing edge and oriented perpendicular to the bottom surface; and a contoured upper surface extending from the first side edge to second side edge, the contoured upper surface intersecting with the first end surface and the second end surface. In at least one such embodiment, the contoured upper surface comprises two convex surfaces and a concave surface. In at least one such embodiment, the concave surface the contoured upper surface is between the convex surfaces the contoured upper surface. In at least one such embodiment, the orthopedic pillow comprises a compressible material. In at least one such embodiment, when the compressible material is under pressure it compresses, and when the pressure is relieved the compressible material returns to substantially its original shape. In at least one such embodiment, the compressible material comprises a urethane foam. In at least one such embodiment, the first end surface extends from the bottom surface to a lesser extent than the second end surface extends from the bottom surface. In at least one embodiment, an orthopedic pillow according to the present disclosure comprises a collapsible air bladder. In at least one such embodiment, a compressible material surrounds the collapsible air bladder

The present disclosure includes disclosure of an orthopedic pillow system. In at least one embodiment, an orthopedic pillow system according to the present disclosure comprises a first orthopedic pillow, the first orthopedic pillow comprising a bottom surface bounded by a leading edge, a trailing edge, and first and second side edges, a first end surface intersecting with the leading edge and oriented perpendicular to the bottom surface, a second end surface intersecting with the trailing edge and oriented perpendicular to the bottom surface, and a contoured upper surface extending from the first side edge to second side edge, the contoured upper surface intersecting with the first end surface and the second end surface; and a second orthopedic pillow, the second orthopedic pillow comprising a top surface bounded by a leading margin, a trailing margin, and first and second side margins, a first end face intersecting with the leading margin and oriented perpendicular to the top surface, a second end face intersecting with the trailing margin and oriented perpendicular to the top surface, a first side face intersecting with the first side margin and oriented perpendicular to the top surface, and a second side face intersecting with the second side margin and oriented perpendicular to the top surface; wherein the bottom surface of the first orthopedic pillow is in contact with the top surface of the second orthopedic pillow.

The present disclosure includes disclosure of methods of alleviating shoulder joint strain. In at least one embodiment, a method of alleviating shoulder joint strain comprises the step of inserting an orthopedic pillow under a torso of a person lying in a lateral decubitus position, the orthopedic pillow comprising: a bottom surface bounded by a leading edge, a trailing edge, and first and second side edges, a first end surface intersecting with the leading edge, and oriented perpendicular to the bottom surface, a second end surface intersecting with the trailing edge, and oriented perpendicular to the bottom surface, and a contoured upper surface extending from the first side edge to second side edge, the contoured upper surface intersecting with the first end surface and the second end surface, wherein the first end extends from the bottom surface to a lesser extent than the second end, and wherein the second end is adjacent the person's axilla. In at least one such embodiment of a method of alleviating shoulder joint strain, the contoured upper surface of the orthopedic pillow comprises two convex surfaces and a concave surface, and the person's torso is in contact with the concave surface. In at least one such embodiment of a method of alleviating shoulder joint strain, the concave surface of the orthopedic pillow is between the convex surfaces. In at least one such embodiment of a method of alleviating shoulder joint strain, the orthopedic pillow is constructed of a compressible material. In at least one such embodiment of a method of alleviating shoulder joint strain, when the compressible material is under pressure it compresses, and when the pressure is relieved the compressible material returns to substantially its original shape. In at least one such embodiment of a method of alleviating shoulder joint strain, the compressible material comprises a urethane foam. In at least one embodiment of a method of alleviating shoulder joint strain wherein an orthopedic pillow comprises a collapsible air bladder, the method comprises the step of inflating the collapsible air bladder.

In at least one embodiment, a method of alleviating shoulder joint strain comprises the step of inserting an orthopedic pillow under a torso of a person lying in a lateral decubitus position, the orthopedic pillow comprising a bottom surface bounded by a leading edge, a trailing edge, and first and second side edges, a first end surface intersecting with the leading edge, and oriented perpendicular to the bottom surface, a second end surface intersecting with the trailing edge, and oriented perpendicular to the bottom surface, and a contoured upper surface extending from the first side edge to second side edge, the contoured upper surface intersecting with the first end surface and the second end surface, wherein the first end extends from the bottom surface to a lesser extent than the second end, and wherein the second end is adjacent the person's axilla; and inserting a second orthopedic pillow under the first orthopedic pillow, the second orthopedic pillow comprising a top surface bounded by a leading margin, a trailing margin, and first and second side margins; a first end face intersecting with the leading margin and oriented perpendicular to the top surface; a second end face intersecting with the trailing margin and oriented perpendicular to the top surface; a first side face intersecting with the first side margin and oriented perpendicular to the top surface; and a second side face intersecting with the second side margin and oriented perpendicular to the top surface. In at least one embodiment of a method of alleviating shoulder joint strain wherein a second orthopedic pillow comprises a collapsible air bladder, the method comprises the step of inflating the collapsible air bladder.

### BRIEF DESCRIPTION OF THE DRAWINGS

FIG. 1 shows an end view of an orthopedic pillow according to at least one embodiment of the present disclosure;

FIG. 2 shows an end view of an orthopedic pillow according to at least one embodiment of the present disclosure;

FIG. 3 shows an end view of an orthopedic pillow used in combination with a secondary pillow, according to at least one embodiment of the present disclosure;

FIG. 4 shows an exploded end view of an orthopedic pillow in combination with a secondary pillow, according to at least one embodiment of the present disclosure;

FIG. 5 shows a side view of an orthopedic pillow according to at least one embodiment of the present disclosure;

FIG. 6A shows a side view of an orthopedic pillow according to at least one embodiment of the present disclosure;

FIG. 6B shows an exploded side view of an orthopedic pillow in combination with a secondary pillow, according to at least one embodiment of the present disclosure;

FIG. 7 shows a perspective view of an orthopedic pillow according to at least one embodiment of the present disclosure arranged in relation to a traditional head pillow; and

FIG. 8 shows a perspective view of an orthopedic pillow according to at least one embodiment of the present disclosure arranged in relation to a traditional head pillow, when in use by an adult user.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of an orthopedic pillow designed to decrease shoulder joint forces when a person is lying in the lateral decubitus position and also the prone position. An orthopedic pillow according to the present disclosure provides for placement of the shoulder in a position whereby the structures within the shoulder, specifically the rotator cuff and subacromial bursa, are not impinged upon. Furthermore, an orthopedic pillow according to the present disclosure provides lateral support for the torso and a broad contact surface area to elevate pressure points. Such a pillow allows a person to use their own head pillow of choice to support their head.

In at least one embodiment, an orthopedic pillow according to the present disclosure is a contoured wedge pillow that supports the chest and back in a comfortable physiologic position and provides for relief of shoulder joint forces. It reduces the pressure exhibited upon the shoulder for side sleepers and prone sleepers and allows for placement of the arm and shoulder in a variety of comfortable positions. An orthopedic pillow according to the present disclosure helps relieve shoulder pain in side sleepers with conditions such as rotator cuff tendinitis, rotator cuff tear, bursitis of the shoulder, arthritic conditions of the shoulder and frozen shoulder, and also reduces pressure on the nerves traveling to the arm through the axilla.

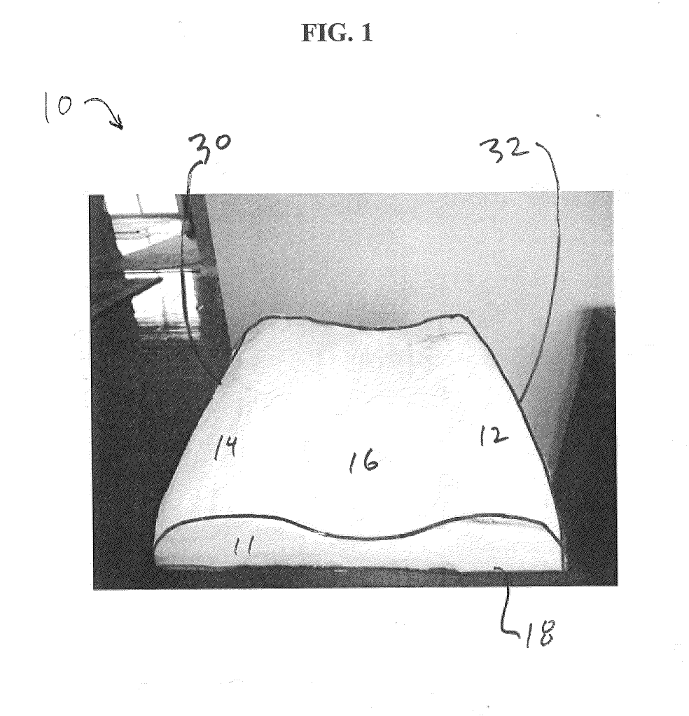

FIG. 1 shows a first end view of an exemplary embodiment of orthopedic pillow 10 according to the present disclosure. In the embodiment shown in FIG. 1, orthopedic pillow 10 comprises first end 11, convex surfaces 12 and 14, concave surface 16, edges 30 and 32, and bottom surface 18. As illustrated in FIG. 1, bottom surface 18 is substantially flat. Edges 30 and 32 extend upwardly from bottom surface 18. Edges 30 and 32 curve to form convex surfaces 12 and 14 at opposite ends of orthopedic pillow 10. Concave surface 16 exists between convex surfaces 12 and 14 of orthopedic pillow 10.

In at least one embodiment, orthopedic pillow 10 is comprised of a urethane foam material. However, other embodiments of orthopedic pillow 10 may be comprised of different materials, including, but not limited to, a low resilience foam, a semi-resilient foam, a visco-elastic foam, or other cushioned material. In at least one embodiment, orthopedic pillow 10 is comprised of a collapsible air bladder surrounded by a urethane foam material or other compressible material. In such an embodiment, in preparation for use the collapsible air bladder is filled with air, such as, for example, through an integrated nozzle or valve. After use, the air may be released from the collapsible air bladder, allowing the collapsible air bladder to reduce in size. An orthopedic pillow 10 according to such an embodiment may be more easily stored and/or transported than an orthopedic pillow 10 according to an embodiment of the present disclosure that is constructed completely of a foam material or other compressible material.

In at least one embodiment, first end 11 at the lowest point of concave surface 16 is approximately 1.5 inches in height, however the height of first end 11 at the lowest point of concave surface 16 may be greater than or less than 1.5 inches in various embodiments. In at least one embodiment, the distance between edges 30 and 32 is approximately 14 inches, however the distance between edges 30 and 32 may be greater than or less than 14 inches in various embodiments.

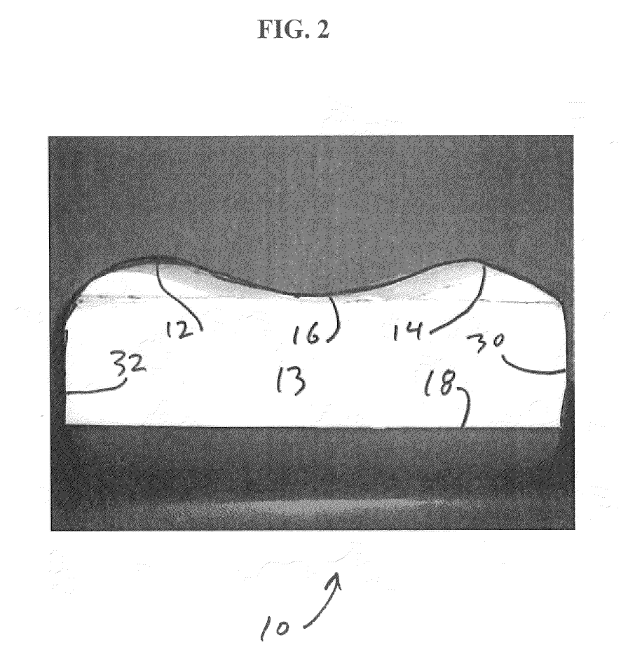

FIG. 2 illustrates a second end view of the exemplary embodiment of orthopedic pillow 10 according to the present disclosure. In the embodiment shown in FIG. 2, orthopedic pillow 10 comprises second end 13, convex surfaces 12 and 14, concave surface 16, edges 30 and 32, and bottom surface 18. In at least one embodiment, second end 13 at the lowest point of concave surface 16 is approximately 3.5 inches in height, however the height of second end 13 at the lowest point of concave surface 16 may be greater than or less than 3.5 inches in various embodiments.

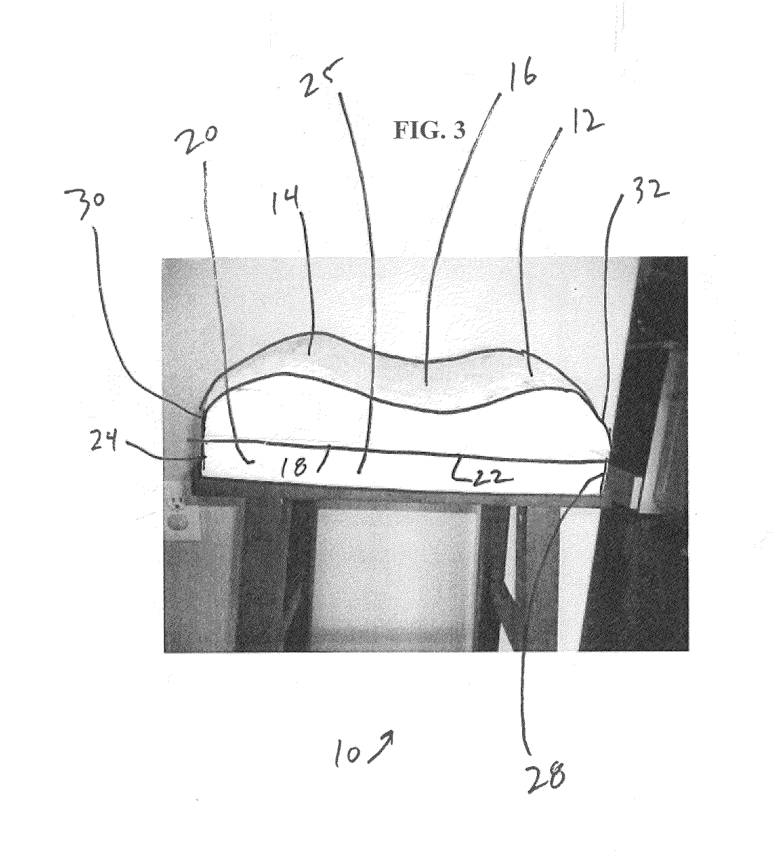

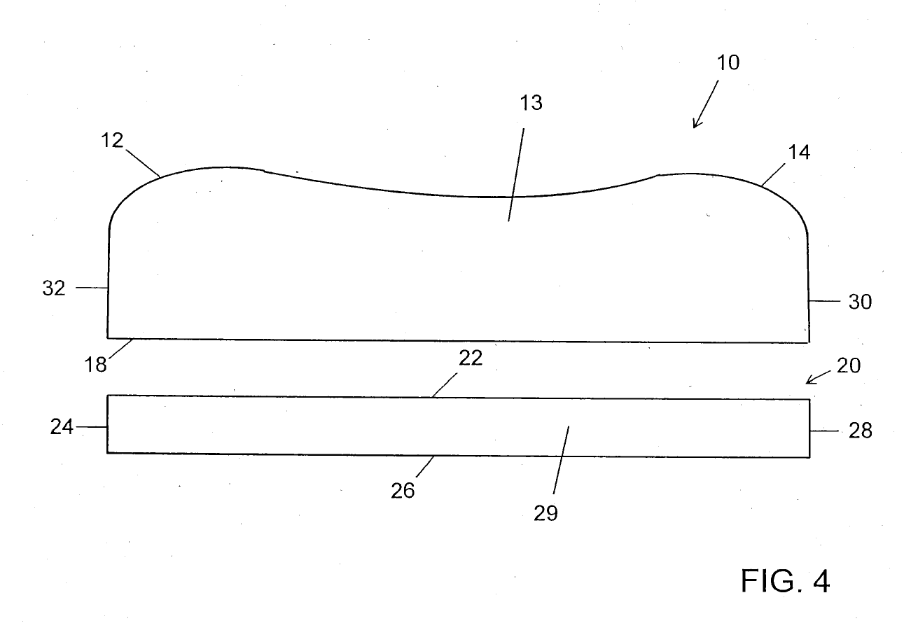

FIG. 3 illustrates an embodiment of the present disclosure where orthopedic pillow 10 is used in conjunction with secondary pillow 20, with orthopedic pillow 10 shown from the perspective of first end 11. FIG. 4 illustrates an exploded view of such an embodiment, with orthopedic pillow 10 shown from the perspective of second end 13. In at least one such embodiment, secondary pillow 20 is hexahedral in shape and includes sides 24, 25, 28, and 29, top surface 22, and bottom surface 26. In at least one embodiment of secondary pillow 20, bottom surface 26 and top surface 22 are rectangular in shape. In at least one embodiment, top surface 22 has substantially the same dimensions as bottom surface 18 of orthopedic pillow 10. In at least one embodiment, secondary pillow 20 measures approximately one inch in height.

In at least one embodiment, secondary pillow 20 is comprised of a urethane foam material. However, other embodiments of secondary pillow 20 may be comprised of different materials, including, but not limited to, a low resilience foam, a semi-resilient foam, a visco-elastic foam, or other cushioned material. In at least one embodiment, secondary pillow 20 is comprised of a collapsible air bladder surrounded by a urethane foam material or other compressible material. In such an embodiment, in preparation for use the collapsible air bladder is filled with air, such as, for example, through an integrated nozzle or valve. After use, the air may be released from the collapsible air bladder, allowing the collapsible air bladder to reduce in size. A secondary pillow 20 according to such an embodiment may be more easily stored and/or transported than a secondary pillow 20 according to an embodiment of the present disclosure that is constructed completely of a foam material or other compressible material.

In a typical deployment, top surface 22 of secondary pillow 20 sits directly below bottom surface 18 of orthopedic pillow 10 in an aligned configuration, to increase the overall thickness of the pillow assembly in order to provide additional support for a user. In such a deployment, the bottom surface 18 of orthopedic pillow 10 aligns with top surface 22 of secondary pillow 20. Top surface 22 of secondary pillow 20 may be adhered to bottom surface 18 of orthopedic pillow 10 to deter movement of orthopedic pillow 10 during use. For example, orthopedic pillow 10 and secondary pillow 20 may be secured together using an adhesive or other bonding method, such as, for example, hook and loop fasteners or other forms of fasteners.

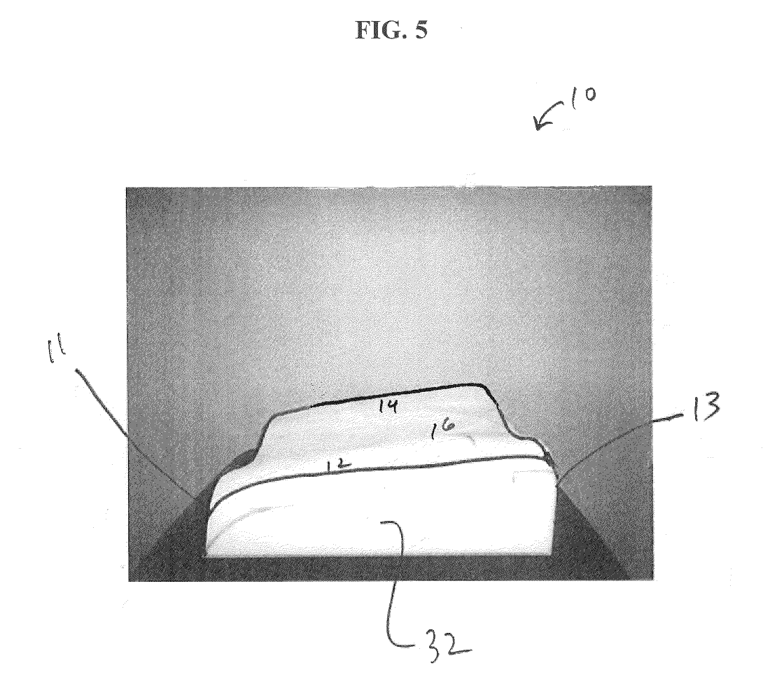

FIG. 5 illustrates a side view of an exemplary embodiment of orthopedic pillow 10 according to the present disclosure, with orthopedic pillow 10 shown from the perspective of side 32. As shown in FIG. 5, in at least one embodiment, first edge 11 has a lower profile than second edge 13, causing orthopedic pillow 10 to take on a wedge shape. In at least one embodiment, the distance between first edge 11 and second edge 13 is approximately 14 inches however the distance between first edge 11 and second edge 13 may be greater than or less than 14 inches in various embodiments. Although not shown in FIG. 5, in at least one embodiment the contours of convex surfaces 12 and 14 and concave surface 16 are substantially constant as orthopedic pillow 10 gradually thickens from first edge 11 to second edge 13. In other embodiments, the relative dimensions of certain features of orthopedic pillow 10 may change from first edge 11 to the second edge 13. For example, convex surfaces 12 and 14 may each decrease in height from first edge 11 to the second edge 13. Similarly, concave surface 16 may decrease in depth from first edge 11 to the second edge 13.

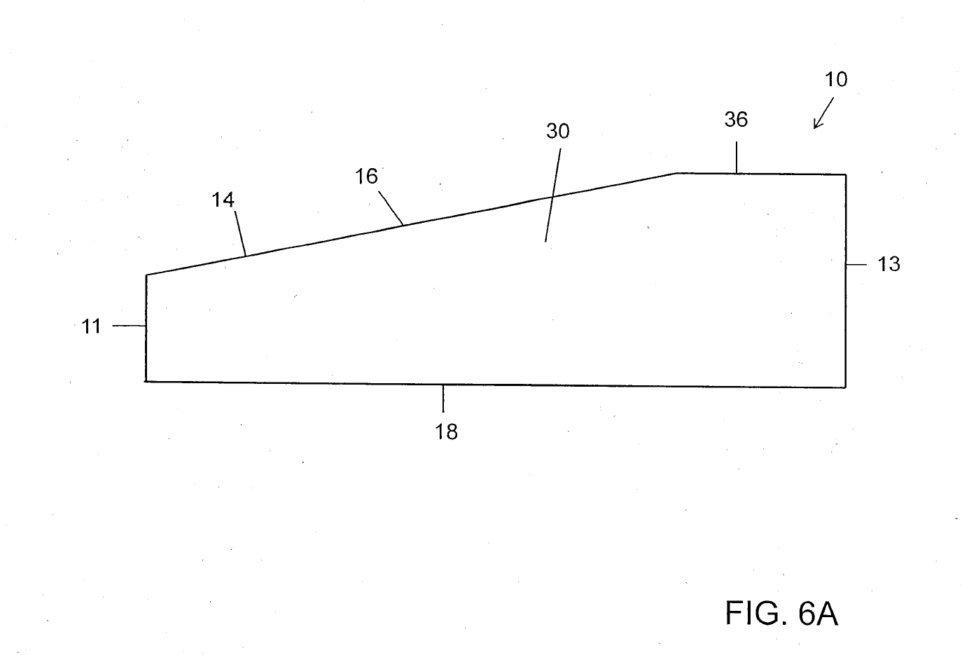

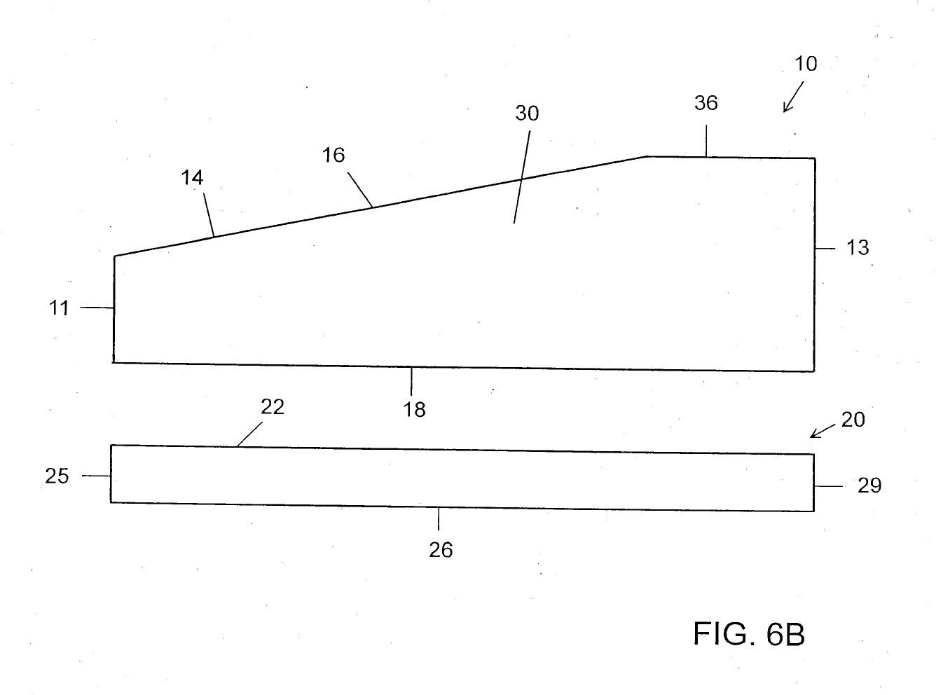

FIG. 6A illustrates a side view of an exemplary embodiment of orthopedic pillow 10 according to the present disclosure, with orthopedic pillow 10 shown from the perspective of side 30. As shown in FIG. 6, in at least one embodiment, first edge 11 has a lower profile than second edge 13, causing orthopedic pillow 10 to take on a wedge shape. In the embodiment shown in FIG. 6A, the thickness of orthopedic pillow 10 is substantially constant for a short distance inward from second edge 13, shown by reference numeral 36 in FIG. 6A. Although not shown in FIG. 6A, in at least one embodiment the contours of convex surfaces 12 and 14 and concave surface 16 are substantially constant from first edge 11 to the second edge 13. In other embodiments, the relative dimensions of certain features of orthopedic pillow 10 may change from first edge 11 to the second edge 13. For example, convex surfaces 12 and 14 may each decrease in height from first edge 11 to the second edge 13. Similarly, concave surface 16 may decrease in depth from first edge 11 to the second edge 13.

FIG. 6B illustrates an exploded view of an embodiment of the present disclosure where orthopedic pillow 10 is used in conjunction with secondary pillow 20, with orthopedic pillow 10 shown from the perspective of side 30.

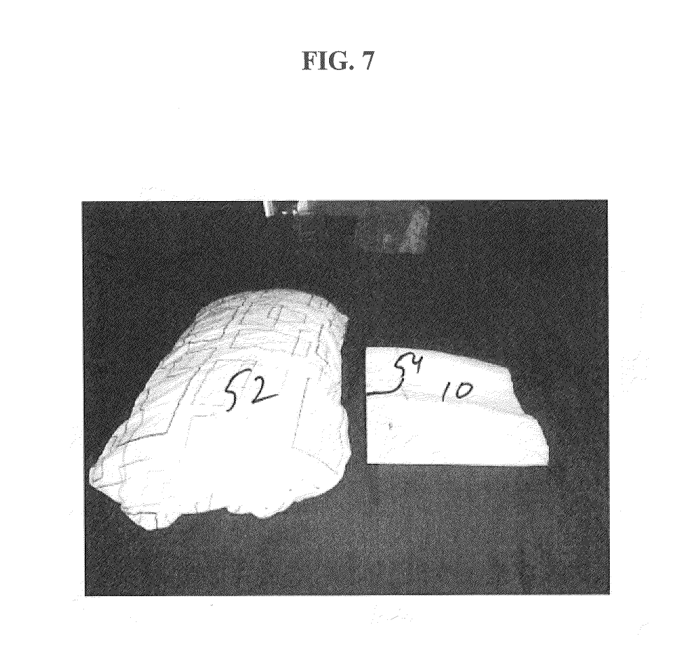

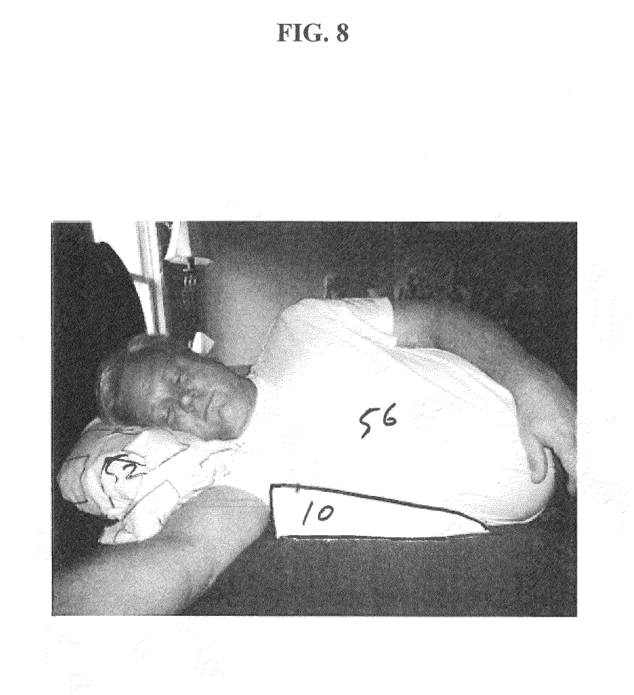

FIGS. 7 and 8 illustrate a typical use of an embodiment of orthopedic pillow 10 according to the present disclosure. As shown in FIG. 7, orthopedic pillow 10 is arranged in relation to a head pillow 52 of a type know in the art. As shown in FIG. 7, orthopedic pillow 10 and traditional head pillow 52 are configured with space 54 between them. FIG. 8 shows orthopedic pillow 10 and head pillow 52 in use by user 56. As shown in FIG. 8, orthopedic pillow 10 provides lateral support for the torso of user 56, and traditional head pillow 52 may be used simultaneously to support the head of user 56. First edge 11 of orthopedic pillow 10 may be positioned near the waist of user 56. Concave surface 16 creates a cupping shape that provides contour support across the body of the user while lying in the lateral decubitus and prone positions. When used as shown in FIG. 8, orthopedic pillow 10 reduces the pressure exerted on the shoulder of user 56 while allowing user 56 to also use traditional head pillow 52.

While this disclosure has been described as having a preferred design, the apparatuses according to the present disclosure can be further modified within the scope and spirit of this disclosure. This application is therefore intended to cover any variations, uses, or adaptations of the disclosure using its general principles. Each such implementation falls within the scope of the present disclosure as disclosed herein and in the appended claims. Furthermore, this application is intended to cover such departures from the present disclosure as come within known or customary practice in the art to which this disclosure pertains and which fall within the limits of the appended claims.

1. An orthopedic pillow configured for placement under a torso of a person lying in a lateral decubitus position, the orthopedic pillow comprising:
a bottom surface bounded by a leading edge, a trailing edge, and first and second side edges;
a first end surface intersecting with said leading edge and oriented substantially perpendicular to said bottom surface;
a second end surface intersecting with said trailing edge and oriented substantially perpendicular to said bottom surface, wherein said first end surface extends from said bottom surface to a lesser extent than said second end surface extends from said bottom surface; and
a contoured upper surface extending from said first side edge to second side edge, said contoured upper surface intersecting with said first end surface and said second end surface,
wherein when placed under a torso of a person lying in a lateral decubitus position, said second end is adjacent said person's axilla.

2. The orthopedic pillow of claim 1, wherein said contoured upper surface comprises two convex surfaces and a concave surface.

3. The orthopedic pillow of claim 2, wherein said concave surface is between said convex surfaces.

4. The orthopedic pillow of claim 1, wherein said orthopedic pillow comprises a compressible material.

5. The orthopedic pillow of claim 4, wherein when said compressible material is under pressure it compresses, and wherein when said pressure is relieved said compressible material returns to substantially its original shape.

6. The orthopedic pillow of claim 4, wherein said compressible material comprises a urethane foam.

7. An orthopedic pillow system comprising:
a first orthopedic pillow, said first orthopedic pillow comprising:
a bottom surface bounded by a leading edge, a trailing edge, and first and second side edges,
a first end surface intersecting with said leading edge and oriented perpendicular to said bottom surface,
a second end surface intersecting with said trailing edge and oriented perpendicular to said bottom surface, and
a contoured upper surface extending from said first side edge to second side edge, said contoured upper surface intersecting with said first end surface and said second end surface; and
a second orthopedic pillow, said second orthopedic pillow comprising:
a top surface bounded by a leading margin, a trailing margin, and first and second side margins,
a first end face intersecting with said leading margin and oriented perpendicular to said top surface,
a second end face intersecting with said trailing margin and oriented perpendicular to said top surface,
a first side face intersecting with said first side margin and oriented perpendicular to said top surface, and
a second side face intersecting with said second side margin and oriented perpendicular to said top surface;
wherein said bottom surface of said first orthopedic pillow is in contact with said top surface of said second orthopedic pillow.
